(19) United States
(12) Patent Application Publication
(10) Pub. No.: US 2012/0078751 A1
(43) Pub. Date: Mar. 29, 2012

(54) Mobile device point of sale transaction system

(76) Inventors: William MacPhail, Mableton, GA (US); James L. Russ, Roswell, GA (US)

(21) Appl. No.: 13/200,442

(22) Filed: Sep. 23, 2011

Related U.S. Application Data
(60) Provisional application No. 61/386,429, filed on Sep. 24, 2010.

(51) Int. Cl. G06Q 30/06

(52) U.S. Cl. 705/26.41

(57) ABSTRACT

A system and method for a more convenient and secure purchase transaction system using a mobile device associated with a user and a COIN financial instrument that is used as a payment instrument between the user and the merchant. The user and the merchant each sign up with the COINS payment transaction system to transmit and use the COIN to transfer a financial payment from an account the user has established with the COIN system to the account of the merchant. The COIN financial instrument is a one-time use financial construct that includes two or more validation and authentication data points, and that is renewed after each transaction with a new, never used COIN financial instrument.

### CROSS REFERENCE TO RELATED DOCUMENTS

This application is related to and claims priority benefit of U.S. Provisional Patent Application 61/386,429 filed Sep. 24, 2010 which is hereby incorporated herein by reference.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

At point of sale locations, consumer purchases are currently handled through cash, check, credit card, debit card and prepaid card transactions, among others. However, consumers often find themselves carrying multiple credit cards. In addition, credit cards can easily be lost or stolen, resulting in fraudulent user. For example, it has been estimated that there was $57 billion in fraudulent credit card loses in 2008 worldwide. Transactions between individuals (person-to-person) can also be cumbersome. A more convenient and secure transaction system would assist in the reduction of credit card losses due to fraud and ease person-to-person transactions.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a block diagram of an exemplary mobile device point of sale transaction system consistent with certain embodiments of the present invention.

FIG. 2a is an illustrative timing diagram of the initiation of a transaction in the mobile device point of sale transaction system consistent with certain embodiments of the present invention.

FIG. 2b is an illustrative timing diagram of the approval of a transaction in the mobile device point of sale transaction system consistent with certain embodiments of the present invention.

FIG. 3 is a block diagram of an exemplary mobile transaction consistent with certain embodiments of the present invention.

FIG. 4 is a block diagram of an exemplary Point-of-Sale (POS) transaction consistent with certain embodiments of the present invention.

FIG. 5 is a block diagram of an exemplary host control transaction process consistent with certain embodiments of the present invention.

FIG. 6 is a view of an exemplary initiation icon on a mobile device display consistent with certain embodiments of the present invention.

FIG. 7 is a view of an initiation display for the mobile device point of sale transaction system consistent with certain embodiments of the present invention.

FIG. 8 is a view of a passcode input display for the mobile device point of sale transaction system consistent with certain embodiments of the present invention.

FIG. 9 is a view of a passcode input retry display for the mobile device point of sale transaction system consistent with certain embodiments of the present invention.

FIG. 10 is a view of a function selection input display for the mobile device point of sale transaction system consistent with certain embodiments of the present invention.

FIG. 11 is a view of a purchase checkout display for the mobile device point of sale transaction system consistent with certain embodiments of the present invention.

FIG. 12 is a view of a purchase confirmation display for the mobile device point of sale transaction system consistent with certain embodiments of the present invention.

FIG. 13 is a view of a purchase approval input display for the mobile device point of sale transaction system consistent with certain embodiments of the present invention.

FIG. 14 is a view of a payment completion display for the mobile device point of sale transaction system consistent with certain embodiments of the present invention.

FIG. 15 is a view of a receipt output display for the mobile device point of sale transaction system consistent with certain embodiments of the present invention.

FIG. 16 is a view of a payment cancellation display for the mobile device point of sale transaction system consistent with certain embodiments of the present invention.

FIG. 17 is a view of a transaction receipt history display for the mobile device point of sale transaction system consistent with certain embodiments of the present invention.

FIG. 18 is a view of a transaction receipt detail display for the mobile device point of sale transaction system consistent with certain embodiments of the present invention.

FIG. 19 is a view of a shop location display on the mobile device point of sale transaction system consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Software and/or firmware embodiments may be implemented using one or more programmed processors executing programming instructions that in certain instances are broadly described above in flow chart form that can be stored on any suitable electronic or computer readable storage medium (such as, for example, disc storage, Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies) and/or can be transmitted over any suitable electronic communication medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

In order to address the desirability of a system that would assist in the reduction of credit card losses due to fraud and ease person-to-person transactions a payment system (referred to herein as a COINS payment product) may be implemented to facilitate payment transactions between any payer (buyer) and any payee (seller). Such transactions may be conducted between consumers and merchants, between businesses (B2B) or between individuals (P2P). A transaction occurring between a consumer and a merchant can be labeled as a Person-to-Business (P2B) or Business-to-Consumer (B2C) transaction. A transaction between businesses may be labeled as a Business-to-Business (B2B) transaction. Additionally, a transaction between individuals may be labeled as a Person-to-Person (P2P) transaction. An exemplary embodiment of a system that may be used to facilitate transactions of each labeled type is produced by COINS Unlimited, LLC of Roswell, Ga., USA.

The payment transaction system, known herein as the COINS payment system (or product) is composed of three parts: an application that is installed upon and runs in an individual's mobile device, an Application Program Interface (API) installed in a merchant's cash register or point of sale device, and a COINS proprietary host server computer system. The COINS application and the COINS API are developed, maintained, and provided to individuals and merchants by COINS Unlimited, LLC. The COINS proprietary host server computer system may be any computer system of sufficient operational characteristics and storage to support all or a designated portion of the COINS system individual and merchant users who are registered as users with the COINS payment system management module. However, the COINS proprietary host server may be comprised of one or more network servers that operate either individually or in a networked operational unit, each of which may be configured to operate and support all users designated by the COINS payment system and is not restricted to any particular geographic location or any single particular computer system.

In an exemplary embodiment, the COINS users, both individual account holders and merchant account holders, preferably go through an initial setup process to be registered with the COINS host server to be able to use the COINS application program as installed on a mobile device to facilitate payment to a COINS payment system capable merchant point of sale device. The setup process in this exemplary embodiment provides for a mobile device owner to open a secure website established and operated by the COINS payment system host server as a user. Upon opening the secure website the user may select a Setup New User Account option. The mobile device owner may then be presented with a display that comprises an online application form. The online application form may include a number of data fields required to establish an account for the mobile device owner. The fields may include, but are not limited to, full name, address, whether the mobile device owner wants to establish a pre-pay account, how the pre-pay account is to be infused with funds from the mobile device owner's bank accounts, whether the mobile device owner establishes a connection with a credit card, and whether the mobile device owner establishes a connection with a Demand Deposit Account (DDA). After the setup information is entered by the mobile device owner the mobile device owner is established as a user of the COINS system.

In this exemplary embodiment, the COINS host server, facilitated by one or more web servers and connected by a secure communication channel, may download the COINS application and the COINS API to the mobile device. During the download action, the User Device Identifier (UDID) is retrieved from the mobile device. In addition, a merchant account is preferably set up with the CONS host by a sales representative who will preferably visit the merchant location and capture the Global Positioning System (GPS) coordinates of the store along with a completed setup form that includes, but is not limited to, owner's name, address, bank account information for deposits, financial history for the business or owner if the store has been in business less than a year, and the business or owner's tax identification number.

Ultimately, COINS Unlimited, through one or more COINS or other servers to include network servers, will use the current electronic funds transfer (EFT) payment process offered by the Federal Reserve through the banking system to move funds from the user's demand deposit account (DDA) to their COINS Unlimited prepay account at initial setup and for the purpose of recharging the prepay account. This operation is known by the term “top off.” The COINS Unlimited host will issue top off transactions when the prepay account reaches a minimum value established by the COINS account holder at the time of the setup of the account. The same initial funding and top off actions will be used to establish credit card accounts where the payment is tied to a credit card instead of a prepay account.

In an exemplary implementation, the COINS accounts are deployed as prepay accounts. In alternate exemplary implementations, the COINS service includes the ability for the COINS account owner to set up prepay options using as a medium of payment multiple credit cards, direct deposit accounts, and line of credit accounts from which the COINS host may pull funds to transfer to the payer in the settlement of payment. The mobile device application may prompt the user to specify the account from which they wish to draw funds to pay the payee. At no time, preferably, will the credit card numbers, the DDA numbers or the line of credit account numbers reside on the mobile device that is running the COINS application module. These numbers will not be made available to any merchant. These numbers will be secured on the COINS host and used to complete payment transactions between the credit card issuers, banks, merchants, and the COINS service provider.
Also, in an exemplary person-to-person implementation, a payee's mobile device may be alternately programmed to function similarly to the POS API, with a camera enabled in the mobile device. The camera may be used to read a machine readable code that is presented on the display of the payer's mobile device. Additional exemplary implementations can include additional options for “reading” machine readable code encoded in formats such as those required for Bluetooth, WiFi, SMS, RFID (NFC) and IrDA, among other formats may be accepted as machine readable coding formats for the purposes of this disclosure. Future methods of communications supported by the payer and payee's applications or devices may also be used to present and/or read a code as presented on the display of the payer's mobile device. In each exemplary implementation for the process embodied in the following description, each block and grouping may represent a module, segment, portion of code, or other programming construct, that may comprise one or more executable or interpretable instructions for performing the specified logical functions within the described process step or portion. It should be noted that the functions described with respect to the blocks may occur in a different order than shown in the figures, and the description may provide embodiments in which certain functions or steps may not be included. In an exemplary description, two or more blocks may be executed substantially concurrently, in a reverse order, or in any other sequence depending on the particular functionality involved. The instructions may be embodied in any computer-readable medium for use by any combination of instruction execution or interpretation systems or devices, such as computer-based systems, processor controlled systems, or any other process instantiated within a computer processor or device. The computer-readable medium may include one or more suitable physical media components configured to store the software, programs, modules, or computer code for a measurable length of time. The computer-readable medium may be any medium configured to contain, store, communicate, propagate, or transport programs for execution by the instruction execution systems or devices.

In an exemplary embodiment, the COINS payment system is composed of three parts: a software application module that is installed and operates on an individual mobile device, an Application Program Interface (API) that is incorporated into the cash register device or point of sale device owned or operated by a merchant, and one or more COINS host server(s). In this exemplary embodiment, communication is established using an encrypted communication protocol between the API operating on the POS device and the COINS host server. The COINS payment system centers around a single use financial instrument or data element, which is called the “COIN”, implementing one or more multi-layered authentication and verification functions supporting payment operations. In this embodiment, once a transaction is initiated the COINS financial instrument cannot be used for another transaction. If a payment transaction is aborted the COINS financial instrument will be rendered valueless and a new financial instrument will be issued to the payer. Since the financial instrument, the COIN, is used only once it is not susceptible to skimming or other forms of theft that plague traditional credit and debit account numbers, and while there is little reason to, the payee or other third party may store the COIN financial instrument after it is used without fear of fraud. In an alternative exemplary embodiment, the COIN financial instrument may be printed on a receipt generated by the merchant. The receipt generated by the merchant to capture and record the transaction will be tracked by the merchant POS or cash register and the COINS host server.

In a preferred embodiment, the payer/buyer may initiate a transaction by initiating the COINS application on a mobile device in the possession of the payer/buyer. The COINS mobile application may then request that the payer/buyer, who is now the user of the COINS mobile application, enter the passcode associated with the user's account within the COINS payment system. The COINS mobile application will recommend the use of a strong passcode. In a preferred embodiment, the strength of the passcode is directly related to the type of keyboard or data entry device that is associated with the mobile device. If the mobile device supports only numeric keys or a numeric keypad is selected as the data entry device of choice, the COINS management application may require the user to enter a numeric passcode that does not contain repetitions of any numbers, or sequences, and contains at least six digits. If the data entry device is alphanumeric, a passcode containing at least six alphanumeric characters, once again with no repeating character or character patterns will be recommended as strong. In addition, in an alternative embodiment, if the mobile device supports a user facing camera, the COINS mobile application may capture a picture of the user as the passcode is entered and the captured picture may be appended to the passcode to increase the strength of the security of the entered passcode. However, the COINS payment system passcode recommendation may be overridden by the user during the user entry of the setup parameters for the account as managed by the COINS host server system application.

The authentication process has a number of layers including host identifiers, mobile identifiers at both the physical and application levels, payer and user passcodes, biometric characteristics, and physical location. The first layer of authentication takes place when the payer enters the assigned alphanumeric passcode. In a preferred embodiment, the COINS mobile application verifies the user's passcode and biometric data against information residing locally within the mobile device. Depending upon the capabilities of the mobile device, biometric authentication of the user may include behavior analysis, key stroke pattern recognition, print matching, image verification, genetic coding, audio analysis, and/or other physical characteristics. In a non-limiting example, the image verification may take the form of facial mapping of the individual using the mobile device by capturing the image of the individual using an embedded camera in the mobile device. This image captured may be compared for matching characteristics at the point of sale prior to the approval of the transaction. In additional non-limiting examples, additional security features may provide for a matching of the geographic location of the merchant compared to the geographic location of the mobile device, through the use of a GPS embedded within the mobile device. The COINS customer may indicate geographic limitations for the operation of the COINS application for purchase transactions. As a further limitation in this example, the COINS application may be set to accept purchase transaction requests only within a given city, state, or other defined geographical area.

Additionally, in a further non-limiting example, the purchase amount for a given purchase transaction may trigger additional authentication requests so as to limit the amount authorized for any given transaction without additional authentication by the user of the mobile application. In this non-limiting example a transaction where the amount of the purchase is under $25, the security approval cycle between the COINS mobile application and the COINS host server may only require the entry of the user's passcode and an indication of approval of the transaction. If the amount is greater than $25, but less than $100, the security approval cycle between the COINS mobile application and the COINS host server may require the additional input of the GPS location of the mobile device to check the device location against the location of the merchant. The approval is denied if the locations are not the same, within a certain pre-determined geographical area limit. If the amount is greater than $100, but less than $500, the security approval cycle between the COINS mobile application and the COINS host server may require the use of the capture of an image of the user and a match through the use of a facial recognition process active on the COINS host server. If the amount is greater than $500, the security approval cycle between the COINS mobile application and the COINS host server may require entry of the passcode, indication of approval, geographic location verification, image recognition verification of the user of the mobile device, as well as the entry into the mobile device of a specially generated high value passcode that is established in addition to the normal passcode used in every purchase transaction.

Another non-limiting example may use the captured voice recording of the individual requesting a transaction using the COINS application on the mobile device and comparing this captured voice recording with a previous recording stored with the authorized user account on the COINS host server. Another non-limiting example may provide for a series of security questions and challenges provided to the COINS mobile application active on the mobile device from the COINS host server. For security reasons the payer's passcode is never shared with any entity outside of the mobile device by the COINS application residing on the mobile device. Upon passing the first layer of authentication, another authentication process step occurs when the mobile device establishes communication with the COINS host server. The mobile device establishes a secure data communication channel with the COINS host server and shares the current single use COIN financial instrument, the unique hardware and COINS application identifiers, the current GPS location for the mobile device, and any account balances locally stored within the mobile device.

The COINS host authenticates the financial instrument stored in the mobile device and validates that it has not previously been used. The COINS host authenticates the mobile device and the COINS mobile application on the mobile device. The COINS host authenticates the condition that the COINS financial instrument is tagged to that specific mobile device and that particular instantiation of the COINS mobile application. The COINS host server authenticates the condition that the payer's accounts/credit lines are tied to the COINS financial instrument. The COINS host logs the physical location of the mobile device in the COINS host data storage array. The COINS host compares the mobile devices account balances and/or available credit lines with the COINS payment system account holder's balances and/or credit lines stored in the COINS host storage array. The COINS host communicates to the mobile device COINS application that the COINS application may proceed with the transaction. The COINS mobile application may establish communication with the merchant cash register or POS prior to receiving the COINS host communication to proceed, but it will not present the financial instrument to the merchant without receiving permission from the COINS host unless the mobile application user overrides the permission requirement, granting express permission for the transaction directly from the user. Permission to override is a condition that may be set in the COINS account holder's setup parameters managed through the proprietary COINS host server. The API will not accept a financial instrument that has not been authenticated by the COINS host unless the merchant agree to override. This exemplary implementation is called an “off-line” condition. The payee's off-line processing parameters are managed through the COINS host.

In the COINS mobile application the user proceeds to the purchase and payment screen to continue with the transaction. The COINS mobile application displays the financial instrument in a non-human readable format. The merchant's representative, who may be the merchant or a cashier or other employee acting on the merchant's behalf, in this exemplary embodiment a cashier initiates the operation of the API by, in a non-limiting example, selecting the COINS financial instrument as the tender or payment choice. The API retrieves transaction and item level purchase data from the cash register or POS. The COINS financial instrument is shared over the secure communication channel between the COINS mobile application and the API on the payee's cash register or POS device. The API communicates with the COINS proprietary host server to request approval of the transaction. The API shares over the secure communication channel the COINS financial instrument previously received from the user's mobile device, the user's COINS identifier, current GPS location, cashier information, transaction and purchase data. The COINS host authenticates the payee's COINS identifier to verify that the merchant has an account set up within the COINS host server, that the merchant is an active merchant and accepting and processing transactions on a regular basis, and that the merchant is authorized by the COINS payment transaction system to accept transactions. The COINS host validates the proprietary COINS financial instrument with the current location of the mobile device. The COINS host validates that the COINS financial instrument has not been previously used for any other transaction. The COINS host compares the transaction total to the user's account balance and/or open line of credit. The COINS host stores the cashier and purchase data received from the API as a part of the management application processing. The management application on the COINS host will also log and tag all transaction and purchase data, inquiries from both merchants and non-merchant users, the use of any coupons during purchase transactions, alerts that may have been set against the accounts involved in the transaction, top off activity for the financial account balances, and downloads to the payer account, payee account, or both accounts involved in the transaction. The COINS host sends an approval request to the COINS mobile application on the mobile device. If insufficient funds are on hand in the user's account, the user will be given the opportunity to transfer additional funds to the account before being prompted to approve the transaction. The COINS mobile application displays an approval screen which includes the payee's name, transaction amount and an account credit confirmation message. The account holder may accept or decline the transaction. The user of the mobile device may then authorize the transaction to complete the financial transaction. The COINS mobile application sends the approval message to the COINS host authorizing the completion of the transaction. The COINS host then creates a new, proprietary and unique COIN financial instrument for the user. The COINS host updates the user's account balance or line of credit. The COINS host transmits the new COINS financial instrument over the secure communication channel established between the COINS host and the user's mobile device for the next, future transaction. The COINS host next transmits the user's updated balances over the secure communication channel to the mobile device. The mobile device stores the new COINS financial instrument for use during the next transaction. The COINS mobile application updates the account holder's balance on the mobile device. The COINS host creates a unique authorization data element which includes specific transaction and account holder identifiers that may later be used as an audit tool for account reconciliation and data discovery.

In this exemplary embodiment, unlike traditional card number the account holder identifier is separate from the COINS financial instrument and is not used in the authorization process but can be used to track buyer purchases on the backend. The COINS host uses a secure communication channel to send an approval message including the unique authorization data element to the API in the POS or the cash register. The API finalizes the financial transaction. The API creates a detailed receipt that may include store information, transaction detail data, item level purchase details, payment detail data, time stamp information, and any other information a merchant may specify for inclusion in the receipt. The API sends the detailed electronic receipt/record to the COINS host. The API may then print a receipt for the cashier to give to the user of the mobile device. Whether a receipt is printed, electronically shared and/or emailed is controlled by the buyer's and seller's profiles. The cashier has the option to issue a printed receipt at the buyer's request. The API shares the approval information with the cash register system or POS. The instantiation of the API completes its operation and exits to the main cash register or POS application. The COINS host stores the electronic receipt for each transaction and associates each transaction with a COINS system user. The COINS host sends the detailed receipt to the COINS mobile application where the electronic receipt is stored on the mobile device. The COINS mobile application may then display the receipt to the user. When the COINS mobile application user indicates that the use of the system is complete by selecting the term “DONE” on the COINS mobile application display, the COINS mobile application returns to the home screen ready for the user to select another application.

In this exemplary implementation, the COINS host server may transmit a copy of the detailed receipt to the account holder's (user's) email account, if the user has selected this option in the account holder preferences stored both within the mobile device for use with the COINS mobile application and on the COINS host server. In this exemplary implementation, a user may select a preference to have a message sent from the COINS host to the user's email account, or to another designated party's email account, that a transaction has occurred and that details of the transaction may be available on the COINS host. Additionally, the COINS host may be enabled to synchronize with, and transmit data to, third party financial management software, a non-limiting example of which would be the Quicken financial management software available from Intuit, Inc.

In an additional exemplary implementation direct-to-direct payment and financial transactions may be performed by the system. In this exemplary implementation a first user of the system may transfer money from their account maintained in the COINS server to the account of another user having an established account with the COINS service provider. To accomplish this transaction, the first user may enter the amount to be transferred from their account into an operational COINS application instantiated on a mobile device associated with the first user. The secure one-time use COIN financial instrument is then displayed on the screen of the mobile device associated with the first user. The second user may activate a COINS application on the mobile device associated with the second user and select an option to receive the transfer. The COINS application initiates the camera associated with the second user's mobile device and initiates a function to place the second user's mobile device into a mode whereby the second user's mobile device is capable of scanning a bar code. The first user may present the screen display of the COIN financial instrument as represented by a scannable bar code to the second user. The second user then uses the bar scan capability of the mobile device associated with the second user to scan and input the barcode from the display screen of the mobile device associated with the first user.

Upon a successful scan of the bar code associated with the COIN financial instrument, the scanned and uploaded bar code representing the COIN financial instrument of the first user may then be transmitted to the COINS server operating the COINS payment service. An approval message is then sent from the COINS server to the first user, to be displayed on the screen display associated with the first user's mobile device. The approval message is a request from the COINS payment system to request verification that the first user approves the payment transaction to the second user. If the transaction has not been indicated as approved by the first user within a pre-determined, configurable time, the transaction may time out. The pre-determined time period may be any time period that the first user has set as a preference during the setup operation when opening an account with the COINS payment system, but, in this non-limiting example may be about 30 seconds. If the first user does not indicate approval within the approval time period, or elects not to approve the transaction and allows the approval request time period to expire without action, the transaction is recorded as a failed transaction. Failed transactions in the COINS payment system may be marked as either timed out or cancelled and no transfer of funds will be performed by the COINS payment system.

If the first user approves the transaction, the funds may then be transferred from the account of the first user to the account of the second user and the account balances updated to reflect the transfer of funds from the first user to the second user. Upon completion of the funds transfer, messages will be sent to both the first user and the second user indicating the completion of the transaction.

In an alternative exemplary embodiment, the COINS payment system may be connected directly to a merchant site through a network communication channel where the merchant is running the COINS merchant application in the POS or cash register device. When a customer informs the merchant, or the cashier working in the merchant site, they will be paying using the COINS payment system, the merchant may take the following action to accept payment using the COINS payment system. The merchant or cashier may ring up the transaction on the POS or the cash register device and then choose COINS as the tender type. The customer may then activate the COINS application on the customer's mobile device. To use the COINS application from the mobile device the location service embedded in the mobile device must be active. If there are multiple COINS users as customers in the merchant site, which in this non-limiting example may be a restaurant, the COINS host server may send a message to the merchant POS or cash register to inform the cashier that s/he must provide the customer with a transaction ID that is provided by the COINS host server. The transaction ID may be numeric or alphanumeric in format, or may take any visual form that the cashier can express to the customer. In a non-limiting example, a transaction ID may consist of a numeric string such as “1342.”

The COINS application on the customer's mobile device may present a data entry screen on the display associated with the mobile device. The data entry screen may have a field that will display the transaction ID as the customer enters the transaction ID into the mobile device through the use of the alphanumeric keypad associated with the mobile device. The COINS application active in the mobile device will accept the input of the transaction ID from the customer and transmit the input transaction ID to the COINS host server. The COINS host server may then compare the input transaction ID transmitted from the mobile device with the transaction ID previously sent from the COINS host server to the merchant POS or cash register. If the transaction ID input at the mobile device does not match the transaction ID sent to the merchant POS, the customer will be prompted to re-enter the transaction ID and the comparison will be performed against the newly entered and transmitted transaction ID. A configurable number of attempts will be accepted before the COINS application on the mobile device will no longer accept input from the customer and advise the customer to contact COINS customer service to report the problem.

If the transaction ID entered in the mobile device and transmitted to the COINS host server match, the COINS application on the mobile device will display the transaction amount on the display screen associated with the mobile device and request the approval of this amount from the user of the mobile device. The customer may then indicate their approval of the amount displayed, the approval transmitted from the mobile device to the COINS host server. After the approval indication is accepted at the COINS host server, a receipt is transmitted from the COINS host server and displayed on the screen associated with the customer's mobile device. The receipt details the purchase approved by the customer and will be saved in the local memory of the mobile device for later retrieval and review.

In an additional non-limiting example, the COINS payment system may be connected directly to a merchant site through a network communication channel where the merchant is running the COINS merchant application in the POS or cash register device. When a customer informs the merchant, or the cashier working in the merchant site, they will be paying using the COINS payment system, the merchant may take the following action to accept payment using the COINS payment system. The merchant or cashier may ring up the transaction on the POS or the cash register device and then choose COINS as the tender type. The customer may then activate the COINS application on the customer's mobile device. To use the COINS application from the mobile device the location service embedded in the mobile device must be active. If there are multiple COINS users as customers in the merchant site, which in this non-limiting example may be a restaurant, the COINS host server may send a message to the merchant POS or cash register to inform the cashier of all of the names of COINS users currently at the location that is identified with the geographic position of the merchant site. The cashier may then ask the customer for his/her name so as to identify and select the correct user from the list of users received at the merchant POS or cash register device. After the merchant submits the purchase transactions requested by the properly identified customer for authentication and approval, the COINS host server will send a request to that identified customer for authentication that the purchase transaction is associated with the identified customer. If the COINS user is the identified customer, and the customer indicates the appropriate authentication of his/her identity, the COINS host server will attach the secure COIN financial instrument associated with the properly identified and authenticated user to the merchant transaction. The transaction will then be processed in the same manner as previously described COINS transactions to insure the secure transfer of funds from the account maintained on the COINS host server by the identified and authenticated customer to the account maintained by the merchant.

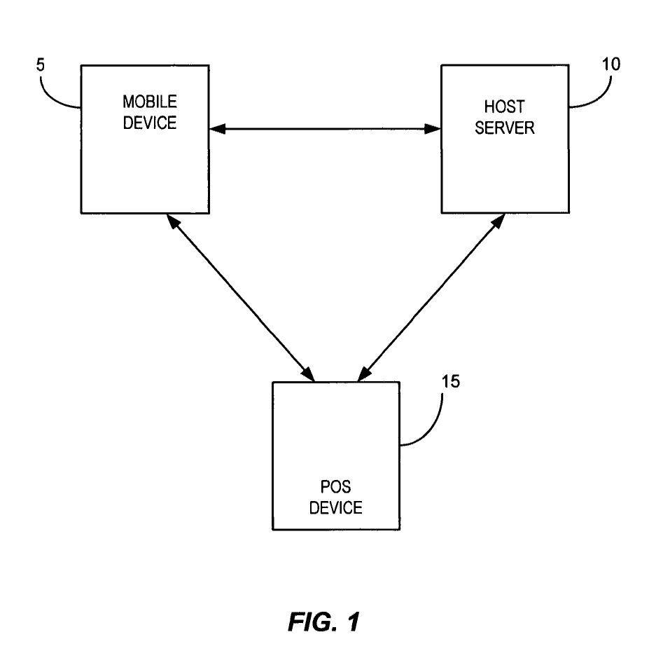

Turning now to FIG. 1, consistent with certain embodiments of the invention, this figure presents an exemplary view of one possible system configuration. In this exemplary configuration, a mobile device 5 is in secure communication with a POS device 15 and transmitting optical bar code information to the POS device 15. The POS device 15 is in communication with a COINS host 10 across a bi-directional communication channel. The COINS host 10 is in communication with the mobile device 5 across a bi-directional communication channel. In this exemplary configuration, each of the mobile device 5, POS device 15, and COINS host 10 may include one or more specially programmed general purpose or specific purpose processors or microcontrollers for controlling operations and functions. In addition, each device may include internal and external memory devices for storage of functional programming constructs, data, intermediate programming results, and any metadata or other data of any type required by the system during operation. Each device may also include input/output devices, display devices, communication interface devices, and any other device required to facilitate system operation.

Also in this exemplary configuration, the application operating on a mobile device 5 is capable of operation on any one of a number of mobile device platforms, such as an iPhone, Android device, a Pre phone, a Blackberry, and any other mobile device platform that contains a processor, display device, accessible data storage, a bi-directional communication capability, and programmable operation capability. These devices are referred to, collectively, as mobile devices 5. A mobile device 5 is a COINS account user's communication, authentication, and identity verification tool all contained within a single device. The mobile device owner may register the mobile device 5 with the COINS service to establish a payment account with the COINS system. The mobile device 5 registration and setup of an individual COINS account must be completed online prior to commercial use of the COINS payment system. The COINS account registration process will include identifying the mobile device user with the Unique Device Identifier (UDID) of the mobile device 5, establishing a Personal Identification Number (PIN) of at least six digits, characters, or a mix of digits and characters depending upon the implementation of the PIN function, and capturing a picture or voice recording of the mobile device owner. In an exemplary implementation, the picture or voice recording may be used to verify that the mobile device user is the mobile device owner registered with the COINS Payment system.

In an exemplary implementation, a payment system such as, in this non-limiting example, a COINS payment system, facilitates payment transactions between two parties such as the owner of a mobile device 5 and the owner of a POS device 10. Using the COINS payment system financial transactions are conducted between a payer (buyer) and a payee (seller). Such transactions may be conducted between consumers and merchants, between merchants, or between individual consumers. While depicted and described herein as actions carried out in software modules, the processes carried out in secure processor can equivalently be carried out in hardware devices, specialized processors, general purpose processors, hard wired logic or some combination thereof.

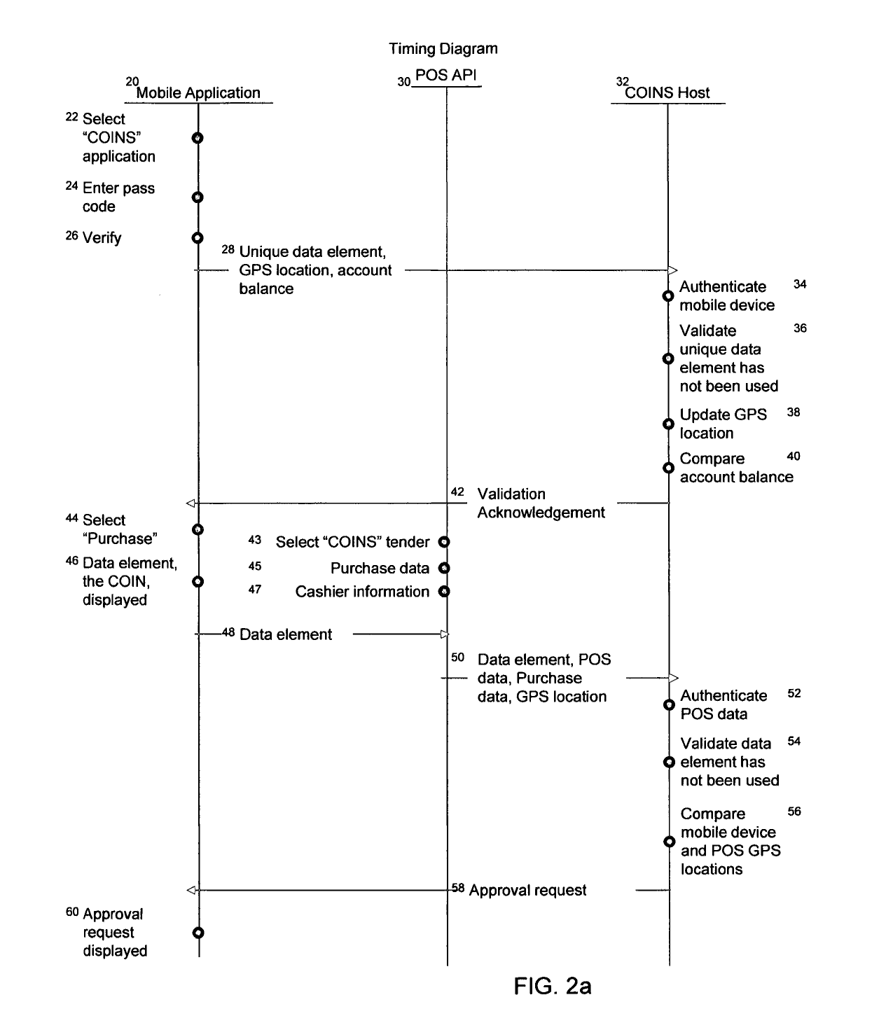

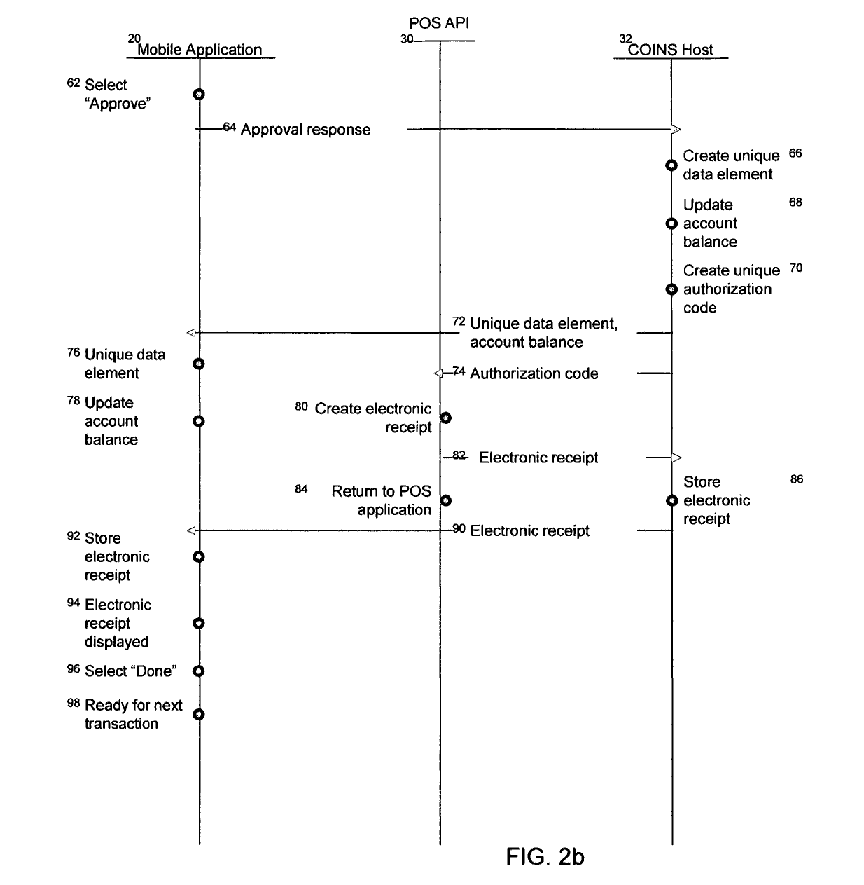

Turning now to FIGS. 2a and 2b, consistent with certain embodiments of the invention these figures present an exemplary timing flow for the process of performing a payment action utilizing the COINS payment system. Three columns represent the mobile device upon which the COINS mobile application 20 is in operation, the POS or cash register upon which the API 30 is installed and operating, and the COINS host 32. As described above, the COINS mobile application 20 is used by the user having installed the COINS mobile application 20 on his/her mobile device and initiated the operation of the COINS mobile application to begin a purchase transaction. The POS or cash register at the merchant site must have the COINS API 30 installed and operating to facilitate the purchase transaction once the user has decided upon a purchase. The COINS host server 32, once again as described above, is in secure communication with the COINS mobile application 20 and the POS or cash register API 30 to manage the financial and operational details of the purchase transaction utilizing the COINS financial instrument as a secure medium of exchange to facilitate the purchase action of the user of the system.

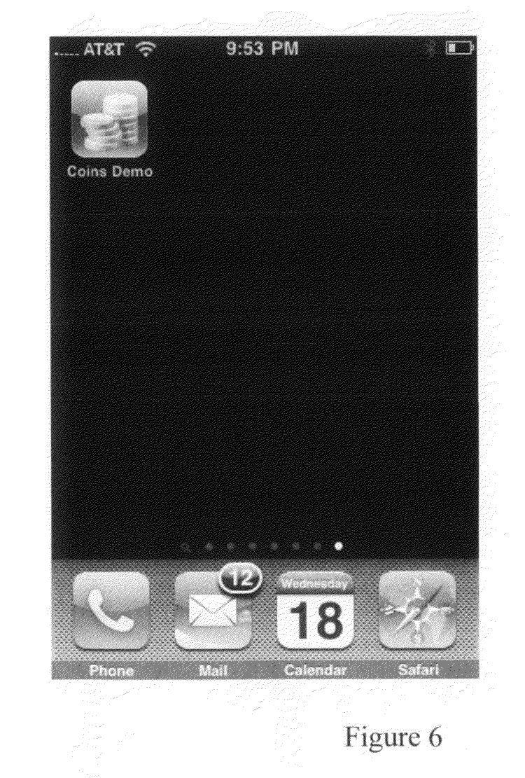

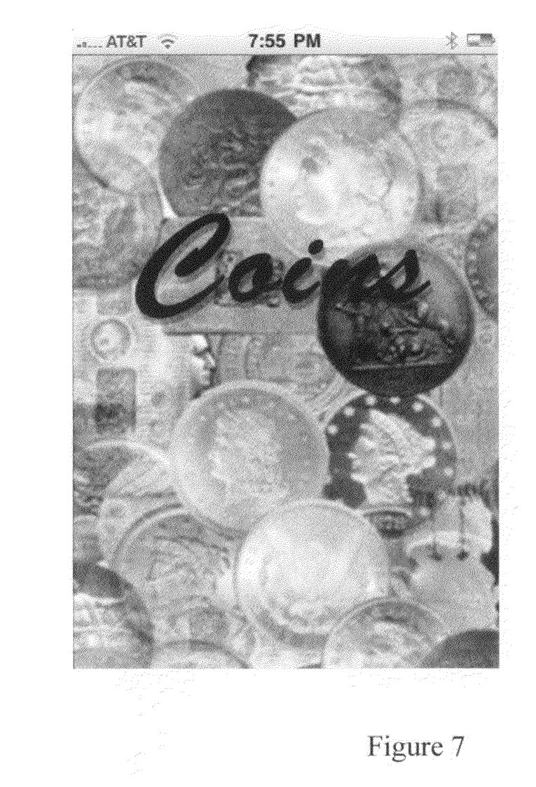

In this exemplary implementation, the user of the mobile device while shopping discovers an item, or items, that the user would like to purchase. The user, in preferring to avoid the possibility of fraudulent activities that can sometimes accompany the swiping of a credit card at the merchant site, may choose to activate the COINS payment transaction system at step 22 that is represented by an icon on the screen display of the mobile device, an exemplary visual representation of which is presented in FIG. 6, by selecting the icon to activate the purchase process. After presenting a COINS splash screen to the user, an exemplary visual representation of which is presented in FIG. 7, the COINS mobile application 20 instantiates the application and loads all data and programming modules required to operate the COINS mobile application 20 on the mobile device, including the next screens for display of options to the user. The instantiation and loading of the COINS mobile application 20 is accomplished utilizing computer processes that are well known and do not need to be further described here.

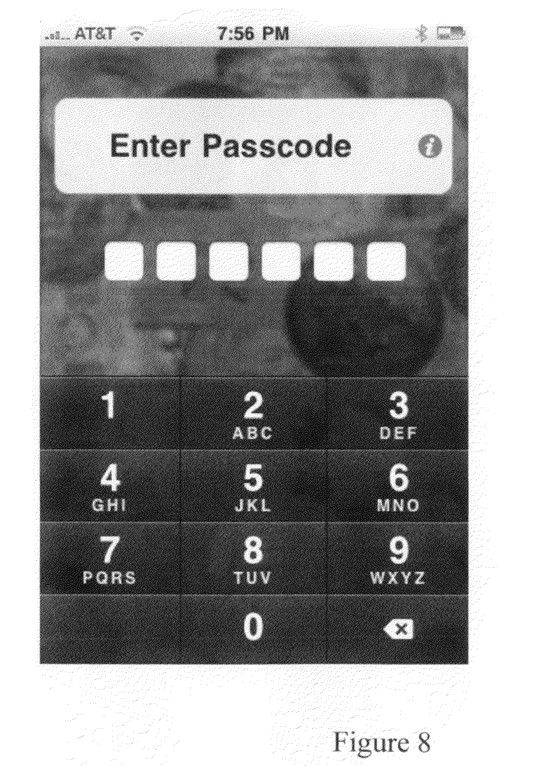

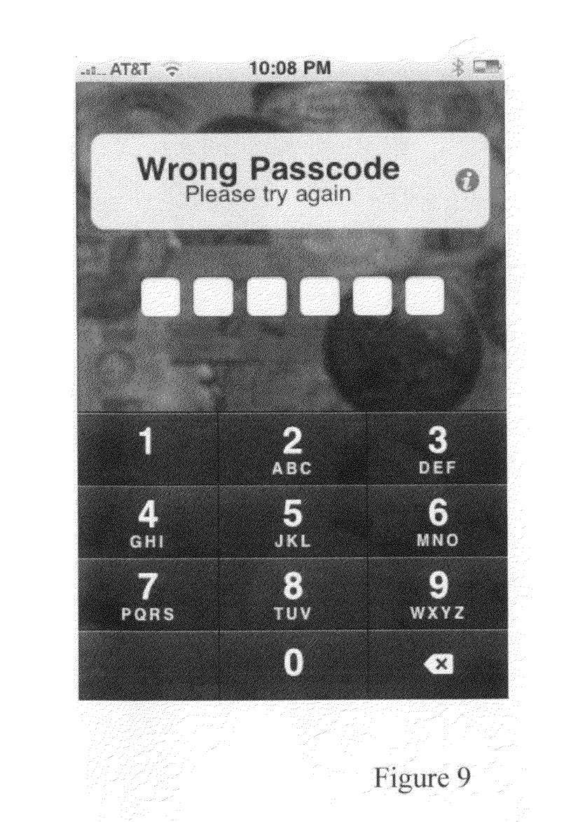

After completing the instantiating and loading operations, in this exemplary implementation, the COINS mobile application 20 may then present the “Enter Passcode” screen, prepared during the presentation of the COINS splash screen, to the user. An exemplary visual representation of the “Enter Passcode” screen is presented in FIG. 8. At step 24, the user may enter the numeric or alphanumeric passcode previously entered as part of the setup process when the user established their COINS user account. At step 26, the COINS mobile application enters a verify process to determine if the passcode entered by the user is a valid passcode for that user and that mobile device. As part of the verification process, if the user has entered a passcode that is not valid, the COINS mobile application may present to the user a “Wrong Passcode” screen, an exemplary visual representation of which is presented in FIG. 9. The user may then have one or more attempts at inputting the correct passcode before the COINS mobile application 20 locks the system against further input. The number of retries is a user or system configurable parameter that is set during the setup process for the COINS mobile application 20 and is downloaded as a part of the COINS mobile application 20 configuration data. If the user is locked out of the use of the system on the mobile device, the mobile device may initiate a call to a COINS Unlimited service representative to assist the user in resolving any problems with the user's passcode problem, or to determine if the mobile device is being used by an unauthorized user.

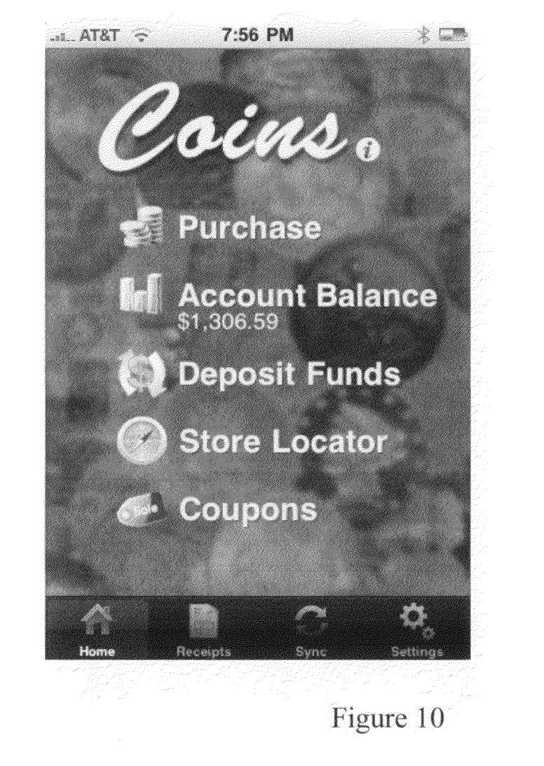

In a preferred embodiment, the COINS Unlimited payment service may provide access to a “911” help passcode. In the event that a COINS Unlimited authorized user is being forced against their will to enter their pass code or to divulge the pass code the user can enter or provide the “call for help” pass code. When the “call for help” pass code is entered the transaction will be approved and the current GPS location will be sent to the local authorities to provide help. This code may also turn on the camera and the microphone to capture one (1) minute of video and audio recording that will also be provided to local authorities. In this preferred embodiment, the authorized COINS payment system user must activate the “call for help” feature prior to use, such as at setup time or at any time prior to the actual use of the system for purchase actions. If the authorized user successfully enters the correct passcode, the COINS mobile application begins a transaction operation and presents the user with a command options screen, an exemplary visual representation of which is presented in FIG. 10.

Further in this exemplary embodiment, at step 26 the parameters for the initiation of a purchase transaction are gathered and transmitted across a secure communication channel to the COINS host server. The data gathered by the COINS mobile application is encrypted to maintain data security as well as being transmitted using any secure transmission protocol that is available and used for secure network communication. The COINS mobile application 20 preferably transmits a minimum of two factors of authentication in order to initiate the transaction process. In an alternative exemplary embodiment, the COINS mobile application 20 may transmit up to three factors of authentication to initiate the transaction process. In the preferred exemplary implementation, the COINS mobile application may transmit a first authentication factor consisting of the UDID associated with the mobile device upon which the COINS mobile application 20 has been loaded. A second authentication factor may consist of the passcode, preferably a 6 digit numeric or 6 character alphanumeric string, as established by the user during the setup of the COINS user account. The UDID and a non-static data element confirming that the passcode entered was the correct passcode as entered by the user and validated by the COINS mobile application 20 are transmitted to the COINS host server 32 for authentication at step 28.

In an alternative embodiment a third authentication factor may be collected from the user by the mobile device and provided to the COINS mobile application for use in the authentication step. This third authentication factor may consist of a plurality of use or user identification factors such as the user's natural rhythm of how the 6 digit passcode is entered into them mobile device, the capture of a short audio sequence of the user's voice, or a photo of the user. It is understood that other factors may be encompassed within this set of factors such as any biometric measurements the mobile device is capable of collecting, or other factors that may be established by the COINS host server 32 that are acceptable as being indicative of the authorized user of the mobile device being used in the transaction. Transmitting three authentication factors minimizes the possibility that an unauthorized user is fraudulently using the COINS payment system.

At step 28, the mobile device may transmit an encrypted message to the COINS host 32. The transmitted message may contain the COIN financial instrument, the current GPS location of the mobile device, and the account balances that are stored on the mobile device. The COIN financial instrument will be checked for prior use, again, the COIN financial instrument is a single use construct, and to determine that the account balances are correct. The current GPS location may be stored in the COINS user account record maintained for this user in the COINS host server storage array. At step 34, the COINS host 32 receives the encrypted data string transmitted from the mobile device. At step 36, the COINS host 32 validates the COIN financial instrument as not having been used previously and, at step 38, the COINS host 32 updates the GPS location of the mobile device in the COINS host server storage array. At step 40, the COINS host 32 compares and validates the account balances maintained on the mobile device with those account balances maintained in the user account storage area in the COINS host server storage array for the user associated with the mobile device. Upon completion of the validation and authorization actions performed by the COINS host server 32, the COINS host server transmits a validation acknowledgement to the mobile application at step 42.

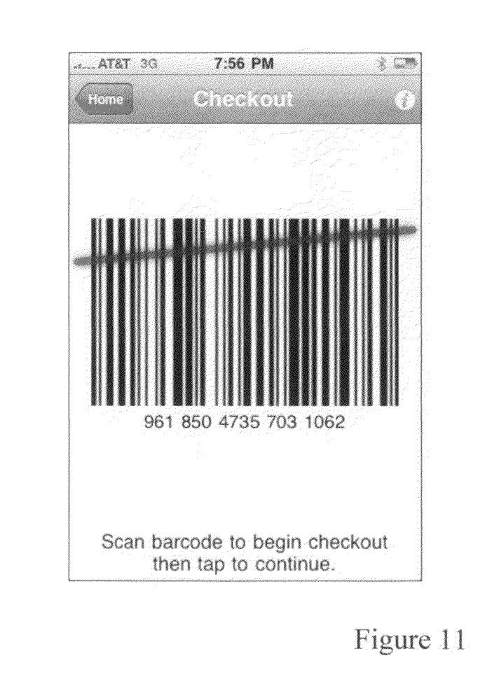

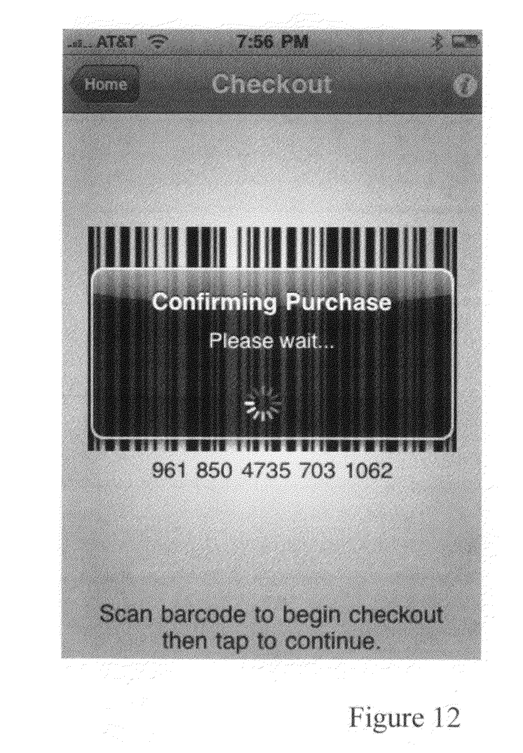

The user may once again be presented with a COINS selection menu screen at step 44, an exemplary visual representation of which is presented in FIG. 10, allowing the user to select a function of the system to begin a payment transaction. If the user selects the “Purchase” option from the display screen, the user initiates a purchase transaction on the mobile device. In an alternative embodiment, the payment screen may be presented to the user in place of the COINS selection menu screen to facilitate and optimize the payment processing, no longer requiring the interaction with the user in the selection of a “purchase” option to continue the transaction. At step 46, as a result of the selection of the purchase option or as a directed option in an alternative embodiment the COIN financial instrument data element is displayed as a machine-readable code. In this exemplary view, the machine-readable code is presented in the form of a bar code and a numerical sequence, an exemplary visual representation of which is presented in FIG. 11. The user presents the mobile device display to the merchant whereupon the merchant may scan the machine-readable code with a scanner, such as, in a non-limiting example, an infrared scanner. It will be recognized by one of ordinary skill in the art that other types of scanners may be used to transfer the information on the display screen to the POS device or cash register. At step 48 the COIN financial instrument data element is transmitted to the POS device or cash register. The COINS API 30 in operation on the merchant POS or cash register then recognizes the incoming COIN financial instrument and selects the “COINS” tender as the transaction begun. The COIN API 30 accumulates the purchase data and cashier information and prepares a data transmission consisting of the COIN financial instrument, the purchase data, and the cashier information, along with any merchant specific information that may be requested for transmission by the merchant when the COINS API 30 setup for the merchant's POS or cash register was performed. The COINS API 30 at step 50 then transmits the COIN financial instrument, purchase data, cashier and merchant information, and the GPS location to the COINS host, an exemplary visual representation of which is presented in FIG. 12. It should be noted that the COIN financial instrument is valid only for the current transaction between a specific user of the mobile device and a specific merchant at a specific GPS location for a limited time. In this exemplary implementation if any of these parameters do not match when examined at the COINS host server, the transaction is invalid and an approval will not be forthcoming from the COINS host server 32.

In this exemplary embodiment the COINS host server 32 authenticates the received POS or cash register data at step 52. The COINS host server 32 validates that the COINS financial instrument transmitted to the server has not been used previous to the current financial transaction, establishing that the COINS financial instrument is valid for use for payment in the current transaction at step 54. At step 56 the COINS host server 32 compares the mobile device UDID against the UDID for the mobile device associated with the user account to verify that the UDID is the same. The COINS host server 32 also verifies that the GPS position for the merchant POS is correct for the merchant associated with the transaction. After the verification and validation actions have been performed, if any of the data transmitted from the user mobile device is not verified or authenticated, a transaction denied and retry is transmitted to the user's mobile device and displayed on the screen. The user is given a configurable number of opportunities to submit the correct COIN financial instrument, purchase data, cashier and merchant information, and the GPS location to the COINS host server 32.

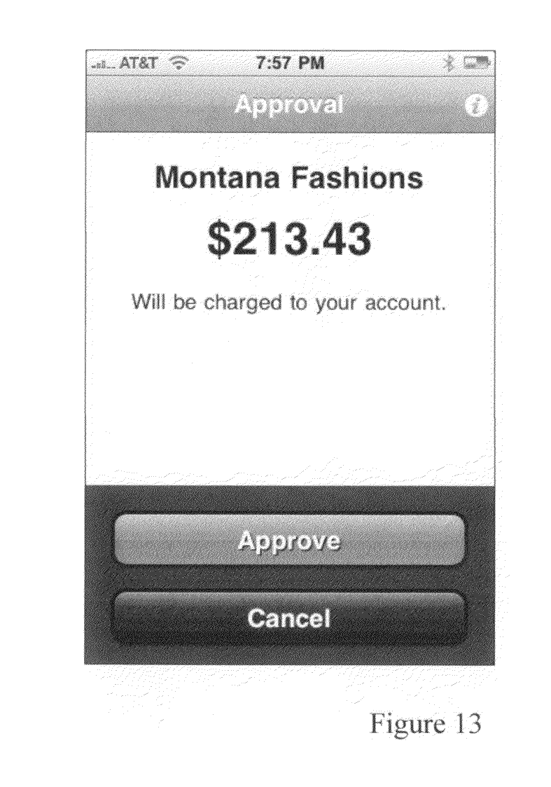

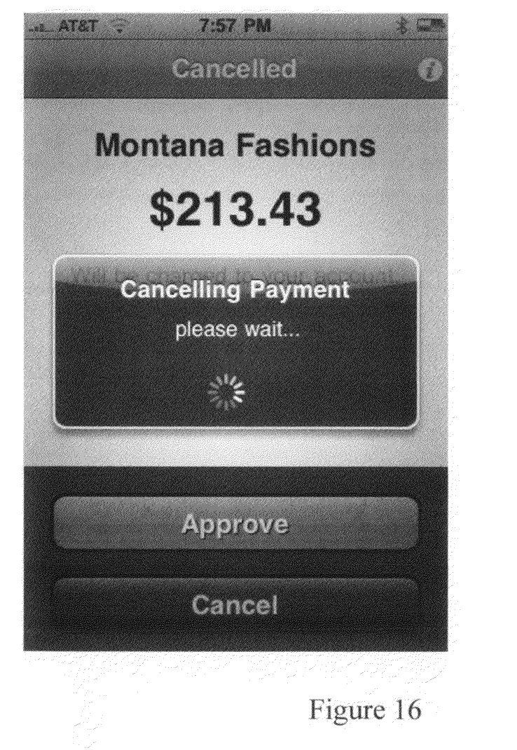

If all data transmitted from the COINS mobile application for the current transaction is authenticated and validated by the COINS host server 32, the server transmits an approval request at step 58. The approval request causes the COINS mobile application 20 to display an approval request screen at step 60 to permit the user to either approve or cancel the pending transaction, providing one last chance for a user to cancel the transaction if the user has changed his/her mind, an exemplary visual representation of which is presented in FIG. 13. At step 62 the user is provided with the option to select “Approve” to continue and initiate the payment transfer portion of the transaction. At step 64 the approval response is transmitted from the COINS mobile application to the COINS host server 32. If the user has chosen not to approve the transaction the payment transfer is not performed by the management application on the COINS host server 32 and the transaction is canceled, an exemplary visual representation of which is presented in FIG. 16. If the user has chosen to approve the transaction the management application operating on the COINS host server 32 creates a new unique COINS financial instrument at step 66, updates the user's account balance to reflect the payment transaction and transfer of funds from the user's account to the merchant account, and at step 70 creates a unique authorization code for this transaction.

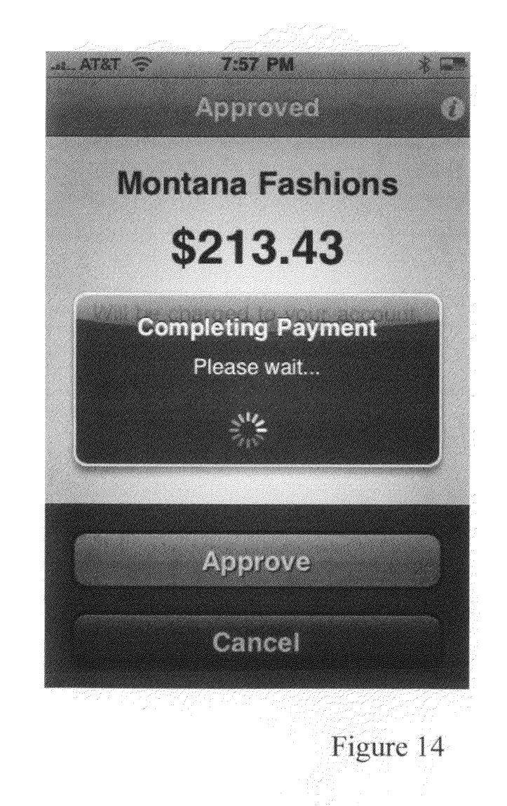

In this preferred embodiment the COINS host server 32 transmits the newly created unique COINS financial instrument and updated account balance to the COINS mobile application at step 72. The COINS host server 32 also transmits the authorization code to the merchant POS or cash register COINS API indicating that the transaction has been approved and that payment has been arranged from the user to the merchant and that the funds transfer is in process or has been completed, an exemplary visual representation of which is presented in FIG. 14. At step 76 the COINS mobile application accepts the transmission from the COINS host server 32 and replaces the COINS financial instrument used in the most recent financial transaction with the newly created unique COINS financial instrument, thus preparing the COINS mobile application 20 for the next transaction desired by the user of the mobile device. At step 78, the COINS mobile application updates the locally stored account balances with the newly calculated balances transmitted from the COINS host server 32.

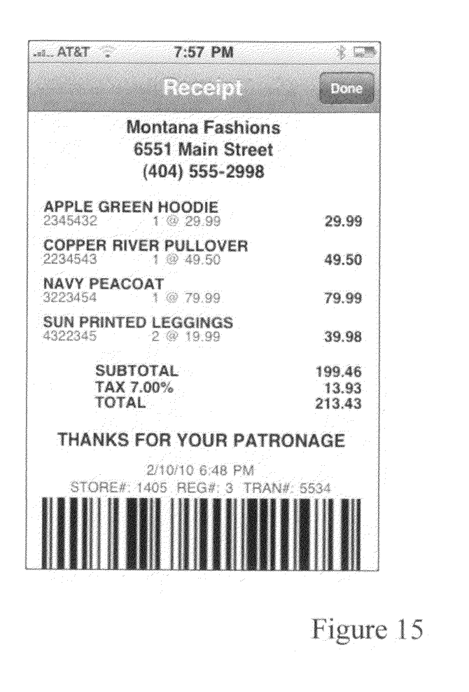

In this preferred embodiment, the merchant POS or cash register device creates an electronic receipt at step 80. The merchant POS or cash register device then uses the COINS API to transmit a copy of the electronic receipt to the COINS host server 32 at step 82. At step 84 the COINS API returns control of the API to the POS or cash register application. The COINS host server 32 then stores a copy of the electronic receipt in the storage array section associated with the mobile device user's account at step 86 and subsequently transmits a copy of the electronic receipt to the COINS mobile application 20 at step 90. At step 90, the COINS mobile application 20 stores the received electronic receipt in the internal memory of the mobile device at step 92. The COINS mobile application 20 then displays a copy of the electronic receipt to the user on the mobile device display at step 94, an exemplary visual representation of which is presented in FIG. 15. The user may download the transaction details to a computer based money management software application maintained on a separate computer and used for tracking the user's financial status. This option provides the user with the ability to safely download the transaction details at the time of occurrence, instead of having to key the details into the money management software application at a later time, thus providing a “greener” solution as no paper receipt is printed and removing the need to have to remember to record the transaction at a later time. The user is once again presented with the COINS application command display screen where the user may select “Done” to indicate that there are no further transactions to be performed at this time at step 96, and the COINS mobile application returns to the icon display indicating the readiness of the system for the next transaction occurrence at step 98.

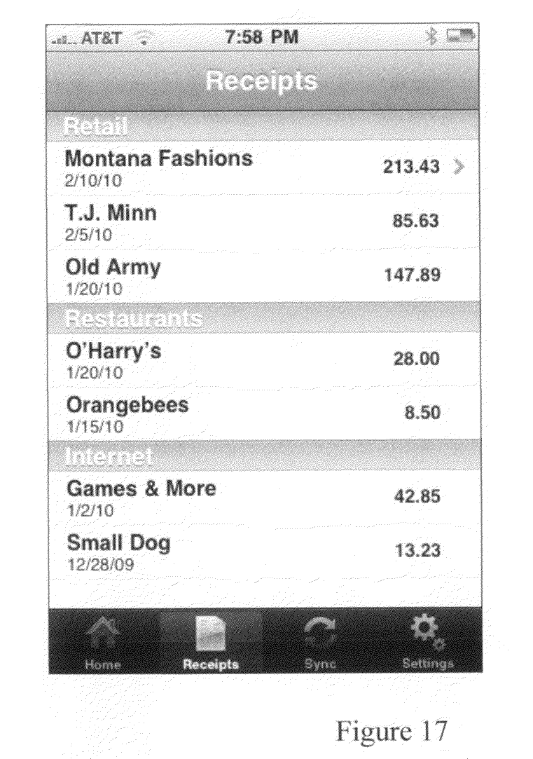

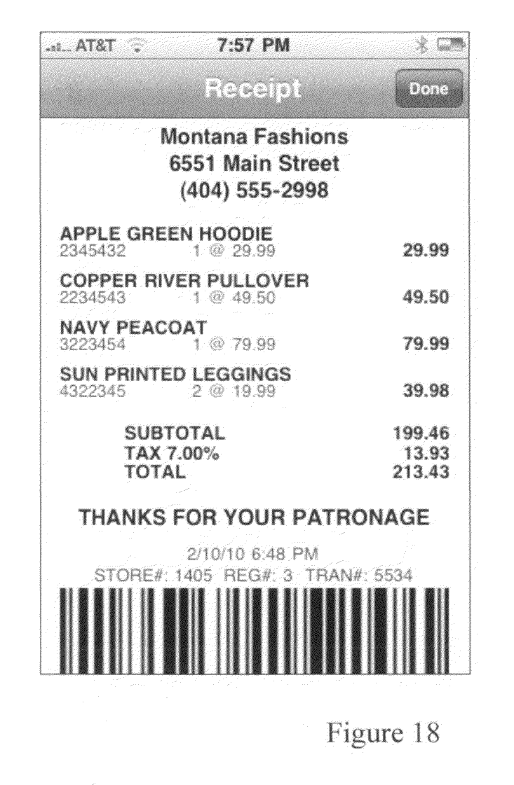

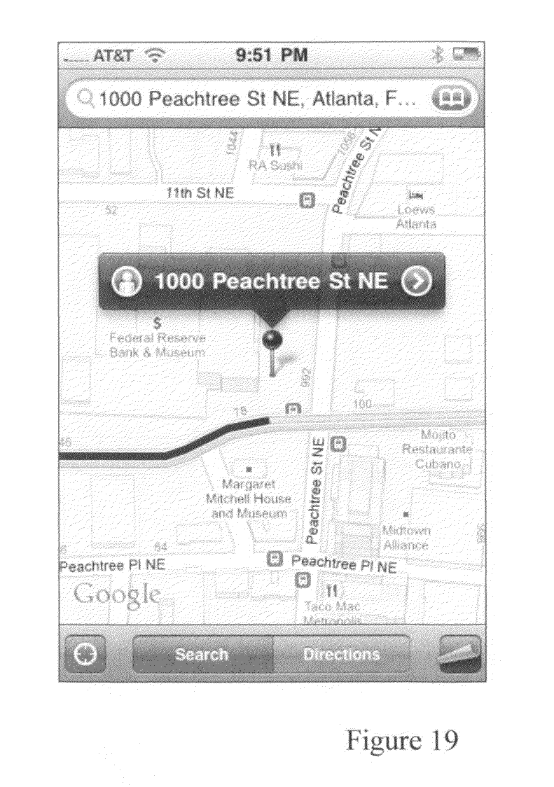

In this preferred embodiment, the user may choose to display more detail by selecting the “receipts” icon located at the bottom of the COINS Main menu display screen. When selected, the action presents a summary history of purchase receipts to the user, an exemplary visual representation of which is presented in FIG. 17. The receipts may be grouped in categories as determined by the merchant's profile stat stored on the COINS host server 32. The selection of one of the summary items displayed initiates the display of a full detailed receipt for that selected summary item, an exemplary visual representation of which is presented in FIG. 18. Also in a preferred embodiment, the GPS location of a merchant of interest may be displayed to a user of the mobile device. A merchant of interest may indicate the merchant associated with a receipt sent to the mobile device, providing a reminder of where a particular item within a receipt was purchased. In an alternative embodiment, the user may request a location of a merchant of interest where the user would like to go to shop for a particular item. In each case, the GPS function in the mobile device may be employed to display a map representation with a location of the merchant of interest, an exemplary visual representation of which is presented in FIG. 19.

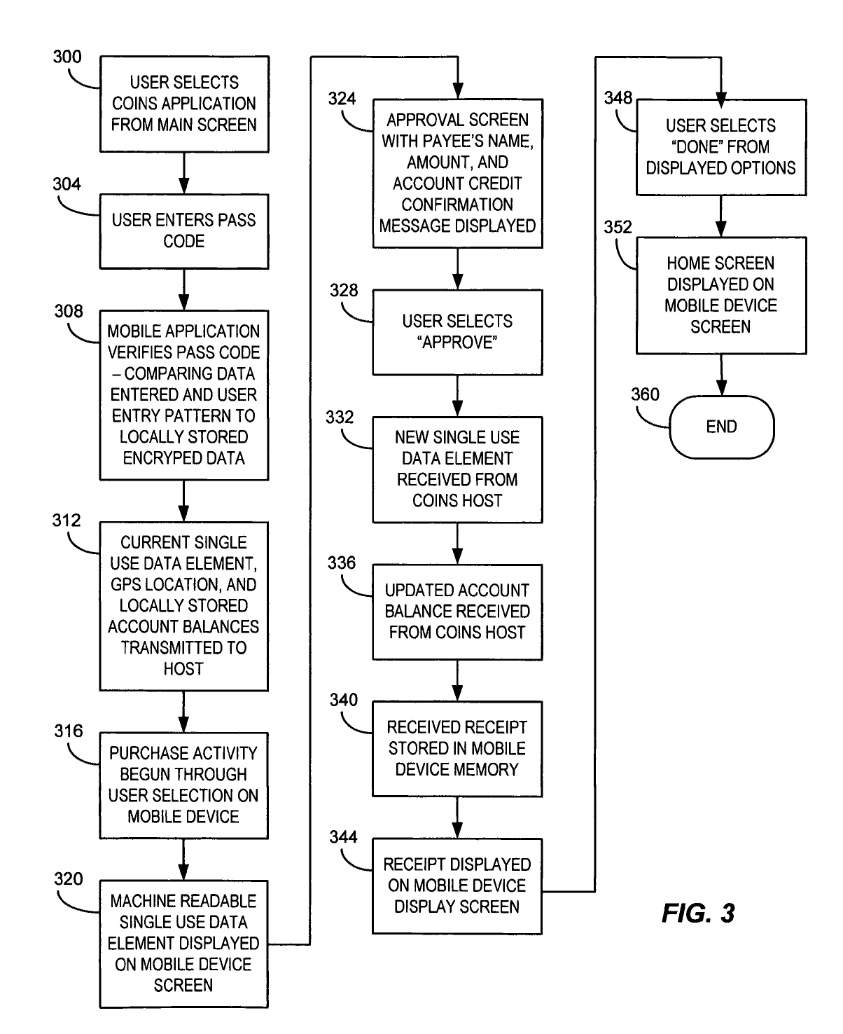

Turning now to FIG. 3, this figure presents an exemplary embodiment of the process flow for the process embodied in the COINS mobile application stored and activated within the mobile device. To activate the COINS payment system the user, who has an active account managed by the COINS payment system, selects the “COINS” icon on the application screen of the mobile device display to initialize the COINS mobile application at step 300. The user will then be requested to enter the secure passcode previously assigned during account setup. The user may enter the passcode at step 304, activating the COINS mobile application capabilities. At step 308 the COINS mobile application may then verify the passcode by comparing the entered data string, whether in numeric or alphanumeric format, entered, as well as the user's entry pattern to the stored data string and entry pattern stored within the memory of the mobile device. In an alternative embodiment, for mobile devices having a camera that faces the user, a picture of the user may be taken at the time the user enters the passcode data string and the picture may be compared to a picture that was taken at the time of initial entry of the passcode data string, and the picture may be used as an additional security check to authenticate the entered passcode. Other embodiments may include additional factors such as the user's natural rhythm of how the six digit passcode is entered into them mobile device or the capture of a short audio sequence of the user's voice.

In this exemplary embodiment at step 312, the currently stored, unused COINS financial instrument, the current GPS location of the mobile device, and the account balances from the mobile device local storage are transmitted to the COINS host server after authentication of the COINS financial instrument. At step 316, the user may select the “purchase” function from a menu display presented on the mobile device display screen, or, in an alternative embodiment, the COINS mobile application may presume that the user intends a purchase activity upon entry of the secure passcode and, after authentication of the passcode, may proceed to the purchase option without the user's intervention. At step 320, the COINS mobile application may display a machine readable single use COINS financial instrument representation for presentation to the merchant by the user. At step 324, after the merchant has captured the machine readable data element, an approval screen is displayed for the user after approval of the transaction that includes the payee/merchant's name, the transaction amount, and an account credit confirmation message.

In this preferred embodiment, at step 328 the user is given the opportunity to select an “approve” option as displayed on the mobile device display screen. If the user decides to approve the transaction, the user simply selects the “approve” option and the COINS mobile application transmits this selection to the COINS host server. The COINS host server creates a new single use COINS financial instrument and transmits this newly created COINS financial instrument to the mobile device, where it is stored in the mobile device memory by the COINS mobile application at step 332. The COINS host server also transmits an updated account balance to the mobile device and the COINS mobile application replaces the account balance in the data storage of the mobile device with the updated account balance newly received at step 336.

The mobile device receives a receipt from the merchant POS or cash register device after the merchant POS or cash register has received a verification of the transfer of funds from the user to the merchant's account, and the receipt is stored in the memory storage of the mobile device by the COINS mobile application at step 340. The COINS mobile application may then display the receipt received from the merchant POS or cash register to the user on the display screen of the mobile device at step 344. The user may then indicate that s/he is finished shopping by selecting the “done” option as presented on the mobile device display at step 348. The COINS mobile application terminates the operation of the application and returns the mobile device screen to the user's preferred home screen to indicate the end 360 of operation.

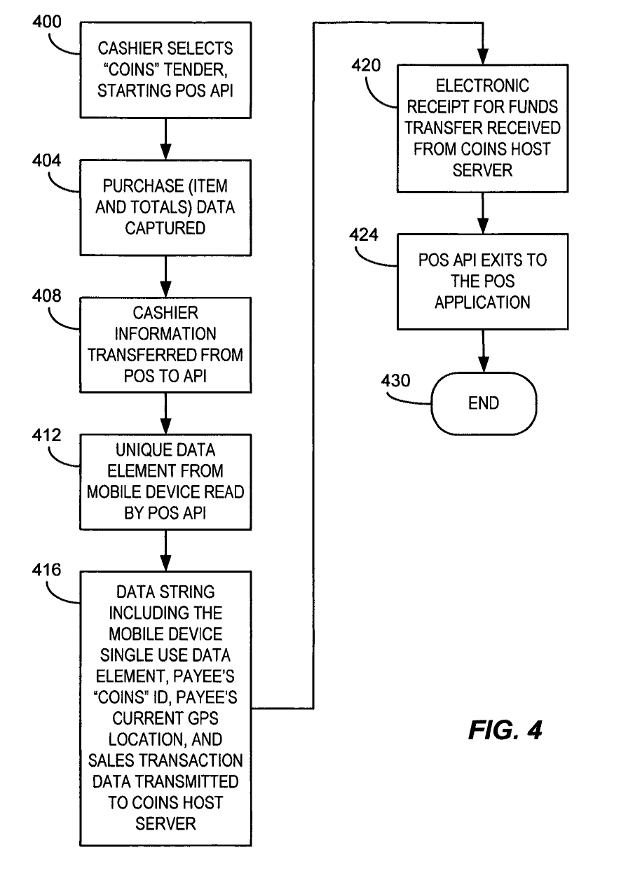

Turning now to FIG. 4, this figure presents an exemplary embodiment of the process flow for the merchant process embodied in the POS or cash register device of the merchant during the payment transaction processing for the COINS payment system. At step 400, a cashier, either the merchant or an agent of the merchant, may select the COINS tender application icon on the POS or cash register to indicate the initiation of a funds transfer in support of a purchase transaction using the COINS payment system. This selection by the cashier or merchant starts the COINS POS API. At step 404, the COINS POS API captures items purchased and purchase amount totals from the POS or cash register device. At step 408, cashier information for the merchant account identification is transferred from the POS device to the COINS POS API. [COULD YOU PROVIDE A BIT MORE EXPLANATION FOR THIS STEP?]. At step 412, the COINS financial instrument representation is presented on the screen of the mobile device which the user shows to the merchant, whereupon the COINS financial instrument representation is read by the POS API for entry into the POS data storage.

In this exemplary embodiment, a data string containing, but not limited to, the single use COINS financial instrument, the payee's COINS identifier, the payee's current GPS location and the sales transaction data is transmitted from the COINS POS API to the COINS host server at step 416. After verification of the purchase transaction, the COINS host transmits an electronic verification of funds transfer to the COINS POS API, whereupon the COINS POS API may store this information as an electronic receipt of funds in the storage of the POS or cash register device at step 420. At step 424, the purchase transaction is complete and the COINS POS API ceases operation and exits to the POS or cash register device.

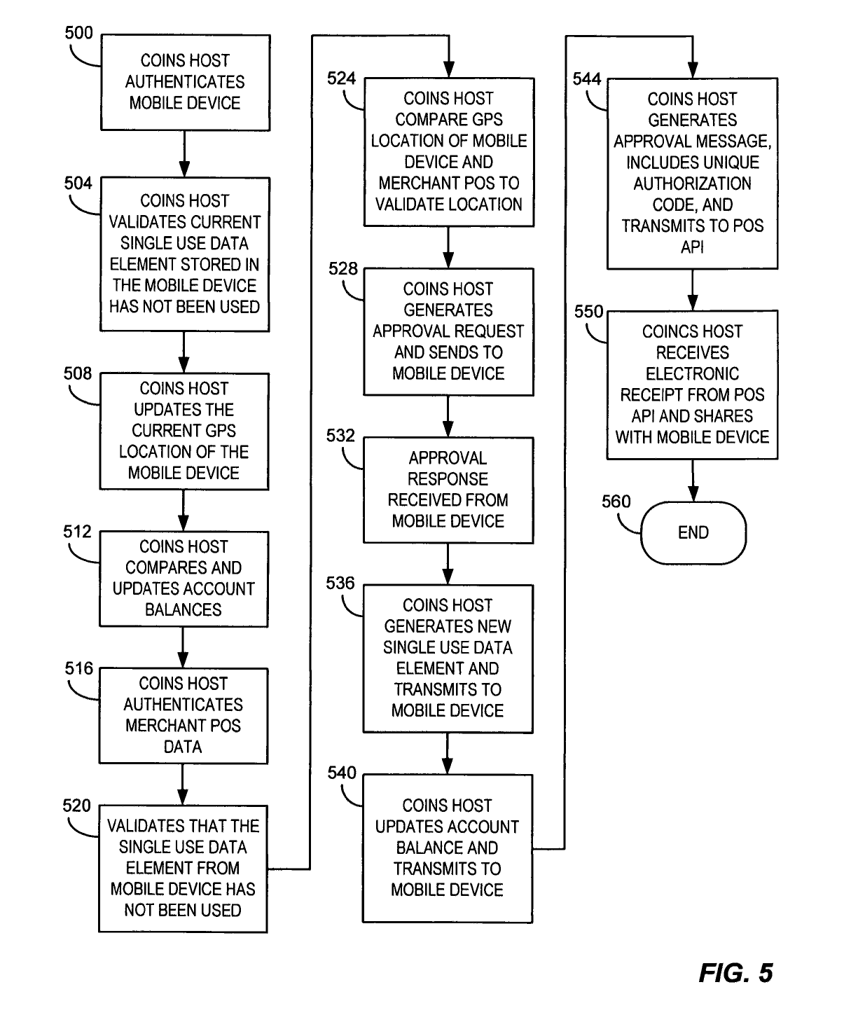

Turning now to FIG. 5, this figure presents an exemplary embodiment of the process flow for the host process embodied in the COINS host server. At step 500, the COINS host server receives a transmission from a mobile device being used by an authorized user of the COINS payment system and the COINS host server then authenticates the mobile device as being authorized for use with the COINS payment system. At step 504, the COINS host server validates the transmitted, current single use COINS financial instrument stored within the mobile device as not having been used. At step 508, the COINS host server updates the GPS location for the current location of the authenticated mobile device. At step 512, the COINS host server compares the account balance transmitted from the mobile device with the account balance associated with the mobile device user as stored within the COINS host server storage array. This verification is then transmitted to the mobile device.

In this exemplary embodiment, at step 516 a merchant POS or cash register device transmits identification data to the COINS host server for a payment transaction. At step 520, the COINS host server validates the COINS single use financial instrument transmitted from the mobile device has not been used. The COINS host server then compares the mobile device and merchant POS GPS positions to authenticate that the transaction is occurring at the indicated merchant POS. At step 528, if the GPS positioning is authenticated, the COINS host server will transmit to the mobile device an approval request for the requested transaction on the part of the merchant. At step 532, if the user intends to continue with the purchase transaction, the approval response from the mobile device is transmitted to the COINS host server.

In this preferred embodiment, the COINS host server will then create a new, unused COINS financial instrument at step 536, and update all affected account balances at step 540 and transmit both the newly created, unused COINS financial instrument and the updated account balances to the mobile device. At step 544, the COINS host server will create an approval message that includes a unique authorization code, separate from the COINS financial instrument, and transmit this unique authorization code to the COINS POS API currently operating on the merchant's POS or cash register device. At step 550, the merchant COINS POS API transmits and electronic receipt of the activity to the COINS host server, which the COINS host server stored in the account for the user and transmits a copy thereof to the COINS mobile application in operation on the mobile device.

While certain illustrative embodiments have been described, it is evident that many alternatives, modifications, permutations and variations will become apparent to those skilled in the art in light of the foregoing description.

What is claimed is:

1. A method for performing secure purchase transactions using a mobile device, comprising:
transmitting a purchase request from a mobile device to a server system using an encrypted data transmission;
receiving an approve transaction message from the server at the mobile device;
transmitting an approval from a user upon display of the received approve transaction message;
receiving at least a unique authorization code from the server in response to user generated approval transmission;
displaying a financial instrument to a merchant on the display device associated with the mobile device;
permitting the financial instrument to be scanned and captured from the mobile device display by a merchant;
receiving and storing an electronic receipt associated with the transaction from the server;
displaying the receipt on the mobile device display wherein the data displayed is sufficient to provide a visual verification of the transaction to a user viewing the displayed receipt.

2. The method of claim 1, where the financial instrument is a one-time use financial instrument stored within the storage array of the mobile device.

3. The method of claim 2, further comprising transmitting the one-time use financial instrument in association with the transmitted purchase request.

4. The method of claim 3, where the financial instrument provides the authority for the transfer of funds from an account associated with the mobile device and maintained on the server to an account associated with the merchant.

5. The method of claim 1, where the financial instrument is presented on the display element of the mobile device as a machine-readable code in the form of a bar code and a numerical sequence.

6. The method of claim 2, wherein the approve transaction message from the server is accepted by the mobile device as a validation of the one-time use financial instrument.

7. The method of claim 1, further comprising transmitting the purchase request comprising at least a one-time use financial instrument, account balance information, and Global Positioning System location coordinates for the mobile device.

8. The method of claim 1, where the receipt comprises individual transaction data from the current transaction or the receipt may comprise a list of receipts from which a user may select the receipt to be displayed.

9. The method of claim 2, where a new, unused one-time use financial instrument is generated and transmitted from the server.

10. The method of claim 9, where the new, unused one-time use financial instrument, an updated account balance for the mobile device, and a unique authorization code are received from the server in response to the approval response transmission from the mobile device.

11. A system for performing secure purchase transactions using a networked mobile device, comprising:
transmitting a purchase request from a mobile device to a network server system across a network communication channel using an encrypted data transmission;
receiving an approve transaction message from the server at the mobile device;
transmitting an approval from a user to the network server upon display of the received approve transaction message;
receiving at least a unique authorization code from the network server in response to user generated approval transmission;
displaying a financial instrument to a merchant on the display device associated with the mobile device;
permitting the financial instrument to be scanned and captured from the mobile device display by a merchant;
receiving and storing an electronic receipt associated with the transaction from the network server;
displaying the receipt on the mobile device display wherein the data displayed is sufficient to provide a visual verification of the transaction to a user viewing the displayed receipt.

12. The system of claim 11, where the financial instrument is a one-time use financial instrument stored within the storage array of the networked mobile device.

13. The system of claim 12, further comprising transmitting the one-time use financial instrument in association with the transmitted purchase request.

14. The system of claim 13, where the financial instrument provides the authority for the transfer of funds from an account associated with the mobile device and maintained on the network server to an account associated with the merchant.

15. The system of claim 11, where the financial instrument is presented on the display element of the mobile device as a machine-readable code in the form of a bar code and a numerical sequence.

16. The system of claim 12, wherein the approve transaction message from the network server is accepted by the mobile device as a validation of the one-time use financial instrument.

17. The method of claim 11, further comprising transmitting the purchase request comprising at least a one-time use financial instrument, account balance information, and Global Positioning System location coordinates for the mobile device.

18. The system of claim 11, where the receipt comprises individual transaction data from the current transaction or the receipt may comprise a list of receipts from which a user may select the receipt to be displayed.

19. The system of claim 12, where a new, unused one-time use financial instrument is generated and transmitted from the network server.

20. The system of claim 19, where the new, unused one-time use financial instrument, an updated account balance for the mobile device, and a unique authorization code are received from the network server in response to the approval response transmission from the mobile device.
